(19) United States
(12) Patent Application Publication
(10) Pub. No.: US 2014/0190144 A1
(43) Pub. Date: Jul. 10, 2014

(54) POWER GENERATING SYSTEM AND METHOD FOR OPERATING THE SAME

(71) Applicant: MITSUBISHI HEAVY INDUSTRIES, LTD., Tokyo (JP)

(72) Inventor: Hiroyuki OZAWA, Tokyo (JP)

(73) Assignee: MITSUBISHI HEAVY INDUSTRIES, LTD., Tokyo (JP)

(21) Appl. No.: 14/139,583

(22) Filed: Dec. 23, 2013

(30) Foreign Application Priority Data
Dec. 25, 2012 (JP) 2012-281663

(51) Int. Cl. F02C 3/28; H01M 8/04

(52) U.S. Cl. CPC F02C 3/28; H01M 8/0435; H01M 8/04753; H01M 8/04761
USPC 60/39.12; 429/443

(57) ABSTRACT

A power generating system includes a fuel cell, an exhausted oxidized gas line to which exhausted oxidized gas is discharged from the fuel cell, a gas turbine having a combustor configured to burn an exhausted oxidized gas passing through the exhausted oxidized gas line together with a fuel gas, a temperature detection unit configured to detect a temperature of the exhausted oxidized gas discharged from the fuel cell or a temperature of the exhausted oxidized gas passing through the exhausted oxidized gas line, a fluid supply unit configured to supply a fluid to the exhausted oxidized gas line, and a control unit configured to control an amount of the fluid to be supplied from the fluid supply unit to the exhausted oxidized gas line based on a detection result in the temperature detection unit.

### FIELD

The present invention relates to a power generating system including a combination of a fuel cell, a gas turbine, and a steam turbine; and a method for operating the power generating system.

### BACKGROUND

A solid oxide fuel cell (hereinafter, referred to as SOFC) is known as a versatile and highly efficient fuel cell. The SOFC is designed to have a high operating temperature in order to increase the ionic conductivity and thus can use the air ejected from the compressor of the gas turbine as an air (oxidant) to be supplied to the cathode side. The high temperature fuel that have not been used or the exhausted heat in the SOFC can be used as fuel or an oxidized gas in the combustor of the gas turbine. In addition to the SOFC, a molten-carbonate fuel cell is also known as a fuel cell having a high operating temperature. The usage of the exhausted heat from the molten-carbonate fuel cell in cooperation with a turbine is discussed, similarly to the SOFC.

Thus, various combinations of an SOFC, a gas turbine and a steam turbine are proposed as a power generating system capable of achieving a highly efficient power generation, for example, as described in Patent Literature 1 and Patent Literature 2. The combined systems described in Patent Literature 1 and Patent Literature 2 each include an SOFC, a gas turbine combustor that burns the exhausted fuel gas and exhausted air from the SOFC, and a gas turbine having a compressor that compresses the air to supply the air to the SOFC.

The combined systems described in Patent Literature 1 and Patent Literature 2 each reduce the temperature of the exhausted air by exchanging the heat among the exhausted air from the SOFC, and the air to be supplied to the SOFC or the steam to be supplied to the steam turbine using a heat exchanger.

### CITATION LIST

### Patent Literature

Patent Literature 1: Japanese Laid-open Patent Publication No. 11-297336
Patent Literature 2: Japanese Laid-open Patent Publication No. 2004-134262

### SUMMARY

### Technical Problem

The discharged gas (the exhausted air or the exhausted fuel gas) from the SOFC has a high temperature in the conventional power generating system and, for example, the temperature of the exhausted air reaches 550 to 650° C. during a rated operation. Thus, it is necessary to design the exhausted air line (pipe) configured to send a high-pressure exhausted air to the gas turbine combustor with a material or a thickness of material that is resistant to the temperature of the high-pressure exhausted air. There is a problem in that the production cost is increased because the material resistant to the assumed pressure and temperature is very expensive and a very thick pipe is made of the expensive material.

In light of the foregoing, the air flowing through the exhausted air (exhausted oxidized gas) line is maintained at a low temperature by a heat exchange in which the temperature of the exhausted air (exhausted oxidized gas) is reduced in Patent Literature 1 and Patent Literature 2. However, there is a room for improvement in order to efficiently use the heat of the exhausted air (exhausted oxidized gas). Note that using a fuel cell other than the SOFC also causes the same problem.

To solve the problems, an objective of the present invention is to provide a power generating system and a method for operating the power generating system that can protect the exhausted air line (exhausted oxidized gas line or pipe) configured to send a high pressure and temperature exhausted air (exhausted oxidized gas) and efficiently use the heat of the exhausted air (exhausted oxidized gas).

### Solution to Problem

According to an aspect of the present invention, a power generating system includes: a fuel cell; an exhausted oxidized gas line to which an exhausted oxidized gas is discharged from the fuel cell; a gas turbine including a combustor configured to burn an exhausted oxidized gas passing through the exhausted oxidized gas line together with a fuel gas; a temperature detection unit configured to detect a temperature of the exhausted oxidized gas discharged from the fuel cell or a temperature of the exhausted oxidized gas passing through the exhausted oxidized gas line; a fluid supply unit configured to supply fluid to the exhausted oxidized gas line; and a control unit configured to control an amount of the fluid to be supplied from the fluid supply unit to the exhausted oxidized gas line based on a detection result in the temperature detection unit.

Thus, supplying the fluid to the exhausted oxidized gas line with controlling the supply quantity of fluid based on the temperature of the exhausted oxidized gas can efficiently reduce the temperature of the exhausted oxidized gas from the fuel cell with the evaporative latent heat. This can maintain the exhausted oxidized gas within a predetermined temperature range and thus can protect the exhausted oxidized gas line configured to send the exhausted oxidized gas. Supplying the fluid in a liquid form can reduce the power to be supplied to the operating pressure on the exhausted air line, and supplying the fluid to the exhausted oxidized gas line and evaporating the supplied fluid can increase the flow amount of the exhausted oxidized gas. This can increase the power generation amount in the gas turbine. This can protect the exhausted oxidized gas line (pipe) configured to send the exhausted air (exhausted oxidized gas) and can efficiently use the heat in the exhausted oxidized gas.

Advantageously, in the power generating system, the fluid supply unit includes a plurality of nozzles configured to supply the fluid to the exhausted oxidized gas line.

Thus, supplying the fluid from a plurality of nozzles can distribute and supply the fluid into the exhausted oxidized gas line and thus can equalize the temperatures in the exhausted oxidized gas line. This can surely evaporate the supplied fluid.

Advantageously, the power generating system further includes an NOx concentration detection unit configured to detect a nitrogen oxide concentration in a flue gas discharged from the combustor. The control unit increases the amount of the fluid to be supplied from the fluid supply unit to the exhausted oxidized gas line when a nitrogen oxide concentration detected in the NOx concentration detection unit has exceeded a desired controlled concentration.

Thus, the increase in the flow amount of fluid reduces the exhausted oxidized gas temperature and thus can reduce the combustion temperature in the gas turbine combustor. This can prevent the increase in the nitrogen oxide concentration (NOx concentration) in the flue gas. For example, when the nitrogen oxide concentration in the flue gas increases, increasing the supply quantity of fluid can reduce the nitrogen oxide generated in the combustor. This can reduce the nitrogen oxide concentration in the flue gas.

Advantageously, the power generating system further includes an electric generator configured to rotate with a rotational shaft of the gas turbine to generate power. The control unit increases the amount of the fluid to be supplied from the fluid supply unit to the exhausted oxidized gas line when an increase amount of requested output to the electric generator has exceeded an upper limit value.

Thus, increasing the supply quantity of fluid within a range in which the gas temperature is not significantly reduced at the exit of the gas turbine combustor can increase the flow amount of the exhausted oxidized gas to be supplied to the gas turbine and can reduce the temperature of the exhausted oxidized gas to be supplied to the gas turbine combustor. Thus, the fuel flow amount to be supplied to the gas turbine can be increased within a range in which the temperature of the exhausted oxidized gas does not exceed the upper limit temperatures of the combustor and the gas turbine. This can increase the power to rotate the turbine in the gas turbine and thus can increase the power generation amount in the power generating system. This can respond to the case in which the requested output increases in the power generating system.

Advantageously, in the power generating system, the fluid supply unit includes a fluid storage unit configured to store the fluid, a fluid supply line connecting the exhausted oxidized gas line to the fluid storage unit, a fluid control valve provided on the fluid supply line, and a fluid pump provided on the fluid supply line and configured to send fluid out of the fluid storage unit to the exhausted oxidized gas line. The control unit controls an opening and closing of the fluid control valve and a driving of the fluid pump based on the temperature detected in the temperature detection unit.

Thus, controlling the opening and closing of the fluid control valve and the driving of the fluid pump and supplying the fluid to the exhausted oxidized gas line can reduce the temperature of the exhausted oxidized gas to a predetermined temperature or lower and can increase the flow amount of the exhausted oxidized gas.

Advantageously, in the power generating system, water is stored as fluid in the fluid storage unit.

Thus, when the operating condition of the fuel cell changes and then the gas discharged from the fuel cell has a temperature exceeding a desired temperature for the operation or the upper limit of the temperature in the design of the facility, the water is supplied as the fluid to the discharged gas line. Thus, the water is evaporated with the high temperature discharged gas. Thus, the evaporative latent heat can reduce the temperature of the discharged gas.

Advantageously, the power generating system further includes a water recovering unit configured to extract and recover water included in the exhausted oxidized gas or an exhausted fuel gas discharged from the fuel cell. The water recovered by the water recovering unit is stored as the fluid in the fluid storage unit.

Thus, providing the water recovering unit in the system can extract the water condensed in the system and store the water in the fluid storage unit. This can efficiently use the water condensed in the system as the fluid.

According to another aspect of the present invention, a method for operating a power generating system includes: sending an exhausted oxidized gas discharged from a fuel cell through an exhausted oxidized gas line; detecting a temperature of the exhausted oxidized gas discharged from the fuel cell; and determining, based on the detected temperature of the exhausted oxidized gas, an amount of fluid to be supplied in order to supply the determined amount of fluid to the exhausted oxidized gas line.

Thus, supplying the fluid to the exhausted oxidized gas line with controlling the supply quantity of fluid based on the temperature of the exhausted oxidized gas can reduce the temperature of the exhausted oxidized gas from the fuel cell. This maintains the exhausted oxidized gas within a predetermined temperature range and thus can protect the exhausted oxidized gas line configured to send the exhausted oxidized gas. Supplying the fluid to the exhausted oxidized gas line and evaporating the supplied fluid can increase the flow amount of the exhausted oxidized gas and thus can increase the power generation amount in the gas turbine. This can protect the exhausted oxidized gas line (pipe) configured to send the exhausted air (exhausted oxidized gas) and can efficiently use the sensible heat in the exhausted oxidized gas.

### Advantageous Effects of Invention

The power generating system and method for operating the power generating system of the present invention can reduce the temperature of the exhausted oxidized gas from the fuel cell by supplying the fluid to the exhausted oxidized gas line with controlling the supply quantity of fluid based on the temperature of the exhausted oxidized gas. This maintains the exhausted oxidized gas within a predetermined temperature range and thus can protect the exhausted oxidized gas line configured to send the exhausted oxidized gas. Supplying the fluid to the exhausted oxidized gas line and evaporating the supplied fluid can increase the flow amount of the exhausted oxidized gas and thus can increase the power generation amount in the gas turbine. This can protect the exhausted oxidized gas line (pipe) configured to send the exhausted air (exhausted oxidized gas) and can efficiently use the sensible heat in the exhausted oxidized gas.

### BRIEF DESCRIPTION OF DRAWINGS

FIG. 1 is a schematic diagram of the configuration of a power generating system in the present embodiment.

FIG. 2 is a diagram of the configuration of a part of a fluid supply unit in the power generating system according to the present embodiment.

FIG. 3 is a diagram of the configuration of a part of the fluid supply unit in the power generating system according to the present embodiment.

FIG. 4 is a diagram of the configuration of a part of another exemplary fluid supply unit in the power generating system according to the present embodiment.

FIG. 5 is a flowchart describing an exemplary operation of the power generating system according to the present embodiment.

FIG. 6 is a flowchart describing an exemplary operation of the power generating system according to the present embodiment.

FIG. 7 is a flowchart describing an exemplary operation of the power generating system according to the present embodiment.

FIG. 8 is a diagram of a part of the fluid supply unit in the power generating system according to the present embodiment.

### DESCRIPTION OF EMBODIMENTS

Hereinafter, a preferred embodiment of the power generating system and method for operating the power generating system according to the present invention will be described in detail with reference to the appended drawings. Note that the present invention is not limited to the embodiment. When including a plurality of embodiments, the present invention also includes combinations of the embodiments.

### Embodiment

The power generating system according to the present embodiment is a triple combined cycle (registered trademark) including a combination of a solid oxide fuel cell (hereinafter, referred to as SOFC), a gas turbine, and a steam turbine. The triple combined cycle is capable of generating power in three stages of the SOFC, the gas turbine, and the steam turbine by including the SOFC on the upper stream side of a gas turbine combined cycle (GTCC). This can achieve an extremely high power generation efficiency. Note that, although a solid oxide fuel cell is used as the fuel cell of the present invention in the description below, the fuel cell is not limited to this type of fuel cell.

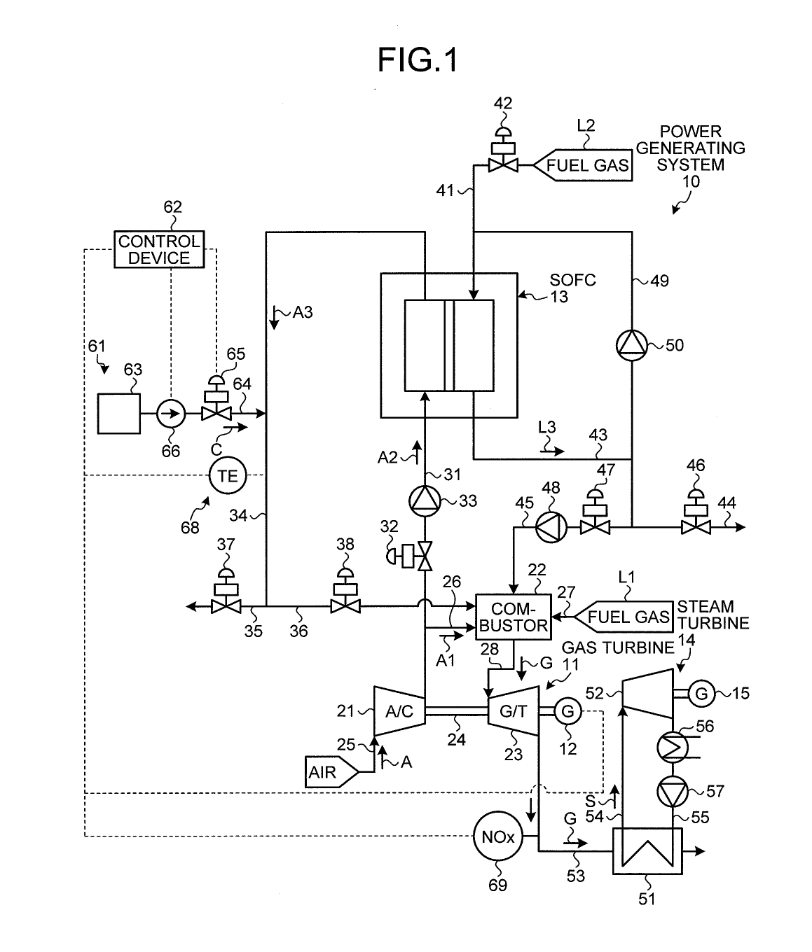

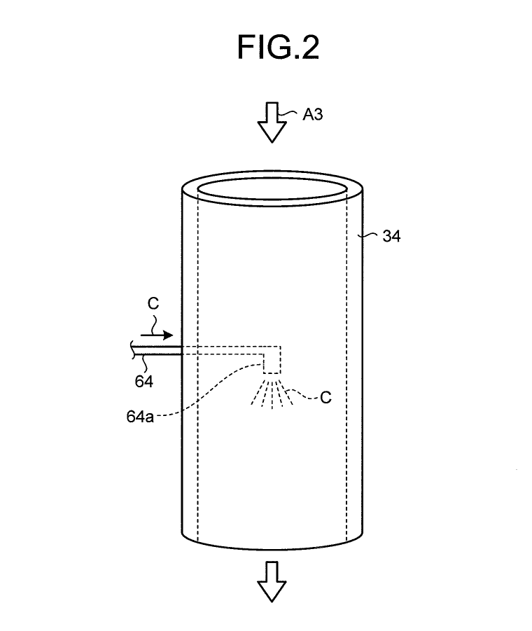

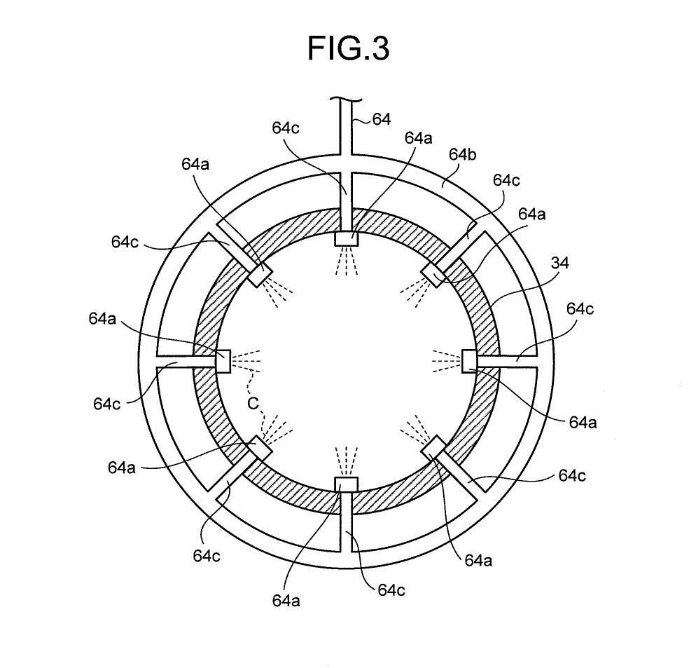

FIG. 1 is a schematic diagram of the configuration of a power generating system in the present embodiment. FIG. 2 is a diagram of the configuration of a part of a fluid supply unit in the power generating system according to the present embodiment. FIG. 3 is a diagram of the configuration of a part of the fluid supply unit in the power generating system according to the present embodiment.

As illustrated in FIG. 1, a power generating system 10 includes a set of a gas turbine 11 and an electric generator 12, an SOFC 13, and a set of a steam turbine 14 and an electric generator 15 in the present embodiment. The power generating system 10 is configured to provide a high power generation efficiency by combining the power generation with the gas turbine 11, the power generation with the SOFC 13, and the power generation with the steam turbine 14.

The gas turbine 11 includes a compressor 21, a combustor 22, and a turbine 23. The compressor 21 is connected to the turbine 23 through a rotating shaft 24 to be able to integrally rotate. The compressor 21 is configured to compress an air A from an air intake line 25. The combustor 22 is configured to mix and burn a compressed air A1 supplied from the compressor 21 through a first compressed air supply line 26 and a fuel gas L1 supplied from a first fuel gas supply line 27. The turbine 23 is configured to rotate with a flue gas (combustion gas) G supplied from the combustor 22 through a flue gas supply line 28. Note that, although not illustrated in the drawings, the compressed air A1 compressed in the compressor 21 is supplied through a wheel chamber. The compressed air A1 as a cooling air cools a turbine blade and so on in the turbine 23. The electric generator 12 and the turbine 23 are coaxially provided to be able to generate power with the rotation of the turbine 23. Note that the fuel gases including the fuel gas L1 supplied to the combustor 22 and a fuel gas L2 to be described below can apply a gas such as liquefied natural gas (LNG), hydrogen (H₂), hydrocarbon gas including carbon monoxide (CO) and methane (CH₄), a gasified gas using coal or other carbonaceous materials.

In the SOFC 13, power is generated by a reaction of a high temperature fuel gas supplied as a reductant and a high temperature air (oxidized gas) supplied as an oxidant at a predetermined operating temperature. The SOFC 13 includes an cathode, a solid electrolyte, and a fuel electrode (anode) in a pressure container. Supplying a compressed air (compressed oxidized gas) A2 that is a part of the air compressed in the compressor 21 to the cathode and supplying the fuel gas L2 to the fuel electrode (anode) generates power. The oxidized gas supplied to the SOFC 13 includes around 15 to 30% oxygen. Air is representative preferred example of the oxidized gas. However, in addition to the air, the mixed gas of a flue gas and air or the mixed gas of oxygen and air can be used (hereinafter, the oxidized gas supplied to the SOFC 13 is referred to as air).

A second compressed air supply line (compressed oxidized gas supply line) 31 branched from the first compressed air supply line 26 is connected to the SOFC 13 such that the compressed air (compressed oxidized gas) A2 that is a part of the air compressed in the compressor 21 can be supplied to an introduction part of the cathode. The second compressed air supply line 31 is provided, along the direction in which the compressed air A2 flows, with a control valve 32 capable of adjusting the amount of the air to be supplied, and a blower (booster machine) 33 capable of increasing the pressure of the compressed air A2. The control valve 32 is provided on the upper stream side of the direction in which the compressed air A2 flows on the second compressed air supply line 31. The blower 33 is provided on the lower stream side than the control valve 32. Note that the placement of the control valve 32 and the blower (booster machine) 33 is not limited the placement in FIG. 1. The places of the control valve 32 and the blower (booster machine) 33 can be reversed depending on their specification. An exhausted air line 34 configured to discharge an exhausted air (exhausted oxidized gas) A3 used at the cathode is connected to the SOFC 13. The exhausted air line 34 is branched into a discharge line 35 configured to discharge the exhausted air A3 used at the cathode to the outside, and an exhausted air supply line (exhausted oxidized gas supply line) 36 connected to the combustor 22. In other words, the exhausted air line 34 and the exhausted air supply line 36 function as an exhausted air supply line that supplies the exhausted air A3 used at the cathode in the SOFC 13 to the combustor 22. The discharge line 35 is provided with a control valve 37 capable of adjusting the amount of air to be discharged, and the exhausted air supply line 36 is provided with a shutoff valve 38 configured to isolate the system between the SOFC and the gas turbine.

The SOFC 13 is provided with a second fuel gas supply line 41 configured to supply the fuel gas L2 to an introduction part of the fuel electrode (anode). The second fuel gas supply line 41 is provided with a control valve 42 capable of the amount of fuel gas to be supplied. An exhausted fuel line 43 configured to discharge an exhausted fuel gas L3 used at the fuel electrode (anode) is connected to the SOFC 13. The exhausted fuel line 43 is branched into a discharge line 44 configured to discharge the exhausted fuel to the outside, and an exhausted fuel gas supply line 45 connected to the combustor 22. The discharge line 44 is provided with a control valve 46 capable of adjusting the amount of fuel gas to be discharged. The exhausted fuel gas supply line 45 is provided, along the direction in which the exhausted fuel gas L3 flows, with a control valve 47 capable of adjusting the amount of fuel gas to be supplied and a blower 48 capable of increasing the pressure of the exhausted fuel gas L3. The control valve 47 is provided on the upper stream side of the direction in which the exhausted fuel gas L3 flows on the exhausted fuel gas supply line 45, and the blower 48 is provided on the lower stream side than the control valve 47 in the direction in which the exhausted fuel gas L3. Note that the placement of the control valve 47 and the blower (booster machine) 48 is not limited the placement in FIG. 1. The places of the control valve 47 and the blower (booster machine) 48 can be reversed depending on their specification.

The SOFC 13 is provided with a fuel gas recirculation line 49 connecting the exhausted fuel line 43 to the second fuel gas supply line 41. The fuel gas recirculation line 49 is provided with a recirculation blower 50 configured to recirculate the exhausted fuel gas L3 in the exhausted fuel line 43 into the second fuel gas supply line 41.

In the steam turbine 14, a steam S generated in a heat recovery steam generator (HRSG) 51 rotates a turbine 52. A flue gas line 53 from the gas turbine 11 (the turbine 23) is connected to the heat recovery steam generator 51 such that the steam S is generated by a heat exchange between the air and the high temperature flue gas G. The steam turbine 14 (the turbine 52) is provided with a steam supply line 54 and a water supply line 55 between the steam turbine 14 (the turbine 52) and the heat recovery steam generator 51. The water supply line 55 is provided with a condenser 56 and a water supply pump 57. The electric generator 15 and the turbine 52 are coaxially provided such that the rotation of the turbine 52 can generates power. Note that the flue gas G of which heat has been recovered in the heat recovery steam generator 51 is discharged into the atmosphere. Note that, although the flue gas G is used as the heat source for the HRSG 51 in the present embodiment, the flue gas G can also be used as the heat source for various devices in addition to the HRSG.

Hereinafter, the operation of the power generating system 10 in the present embodiment will be described. When the power generating system 10 is activated, the steam turbine 14 and the SOFC 13 are activated after the gas turbine 11 has been activated.

First, the compressor 21 compresses the air A, the combustor 22 mixes and burns the compressed air A1 and a fuel gas L1, and the turbine 23 rotates with the flue gas G in the gas turbine 11. This causes the electric generator 12 to start generating power. Next, the steam S generated in the heat recovery steam generator 51 rotates the turbine 52 in the steam turbine 14. This causes the electric generator 15 to start generating power.

To activate the SOFC 13, the pressurization of the SOFC 13 starts after the compressed air A2 is supplied from the compressor 21, and then the heating starts. While the blower 33 on the second compressed air supply line 31 stops or operates after the control valve 37 on the discharge line 35 and the shutoff valve 38 on the exhausted air supply line 36 are closed, the control valve 32 is opened a predetermined aperture. The power generating system 10 can be provided with a control valve only for pressuring the SOFC 13 and the control valve can be opened a predetermined aperture. Note that the aperture is adjusted at that time in order to control the rate of increase in the pressure. Then, the compressed air A2 that is a part of the air compressed in the compressor 21 is supplied from the second compressed air supply line 31 to the SOFC 13 side. Thus, the supplied compressed air A2 increases the pressure on the SOFC 13 side.

On the other hand, supplying the fuel gas L2 to the fuel electrode (anode) side and supplying a compressed air (oxidized gas) from a branch of a compressed air line (not illustrated in the drawings) starts pressurizing the SOFC 13. The power generating system 10 can be provided with a purge gas supply unit configured to supply purge gas to the fuel electrode (anode) such that supplying the purge gas to the fuel electrode (anode) can increase the pressure on the fuel electrode (anode) side of the SOFC 13. In that case, inert gas, for example, nitrogen can be used as the purge gas. The control valve 42 on the second fuel gas supply line 41 is opened and the recirculation blower 50 on the fuel gas recirculation line 49 is driven while the control valve 46 on the discharge line 44 and the control valve 47 on the exhausted fuel gas supply line 45 are closed and the blower 48 is stopped. Note that the recirculation blower 50 can be activated before the pressurization on the fuel electrode (anode) side. This supplies the fuel gas L2 from the second fuel gas supply line 41 to the SOFC 13 side and recirculates the exhausted fuel gas L3 from the fuel gas recirculation line 49. As a result, supplying the fuel gas L2, the air, the inert gas, and so on increases the pressure on the fuel electrode (anode) side of the SOFC 13.

Once the pressure on the cathode side of the SOFC 13 reaches the outlet pressure of the compressor 21, the control valve 32 controls the flow amount of the air to be supplied to the SOFC 13 and the blower 33 is driven if not being driven. At the same time, opening the shutoff valve 38 supplies the exhausted air A3 from the SOFC 13 through the exhausted air supply line 36 to the combustor 22. Then, the blower 33 supplies the compressed air A2 to the SOFC 13 side. At the same time, the control valve 46 is opened in order to discharge the exhausted fuel gas L3 from the SOFC 13 through the discharge line 44. When the pressure on the cathode and the pressure of the fuel electrode (anode) side of the SOFC 13 reach the desired pressures, the pressurization of the SOFC 13 is completed.

Then, when the control valve 37 has been opened after the pressure of the SOFC 13 is stably controlled, the control valve 37 is closed. On the other hand, the shutoff valve 38 is kept opened. This continues supplying the exhausted air A3 from the SOFC 13 through the exhausted air supply line 36 to the combustor 22. When the composition of the exhausted fuel gas L3 becomes an composition that can be injected into the combustor, the control valve 46 is closed while the control valve 47 is opened so as to drive the blower 48. This supplies the exhausted fuel gas L3 from the SOFC 13 through the exhausted fuel gas supply line 45 to the combustor 22. At that time, the amount of the fuel gas L1 supplied from the first fuel gas supply line 27 to the combustor 22 is reduced.

Then, all of the power generations: the power generation in the electric generator 12 driven by the gas turbine 11, the power generation in the SOFC 13, and the power generation in the electric generator 15 driven by the steam turbine 14 are performed. This causes the power generating system 10 to steadily operate.

By the way, the air discharged from the SOFC 13 (the exhausted air A3 or the exhausted fuel gas L3) has a high temperature. For example, the temperature of the exhausted air A3 reaches 550 to 650° C. during the rated operation.

In light of the foregoing, the power generating system 10 according to the present embodiment is provided with a fluid supply unit (discharged air cooling unit) 61 on the exhausted air line 34 that sends the exhausted air A3 from the SOFC 13 as illustrated in FIG. 1 in order to reduce the temperature of the exhausted air A3. A control device (control unit) 62 is configured to supply a fluid C to the fluid supply unit 61 based on the temperature of the exhausted air A3 from the SOFC 13. In that case, the fluid is in a form that is readily evaporated by heating and changes into gas, such as a liquid form, a mist form, a liquid drop form, or a similar form to them. For example, a liquid typified by water is preferable.

The fluid supply unit 61 provided on the exhausted air line 34 is proximal to the SOFC 13 on the exhausted air line 34 and includes a fluid storage unit 63, a fluid supply line 64, a fluid control valve 65, a fluid pump 66, a temperature detection unit 68, and an NOx detection unit 69.

The fluid storage unit 63 is a container configured to store the fluid C. Note that, for example, water is applied as the fluid C in that case. The water is stored in the fluid storage unit 63.

The fluid supply line 64 connects the exhausted air line 34 to the fluid storage unit 63. As illustrated in FIG. 2, the fluid supply line 64 is provided with a fluid jet nozzle (nozzle configured to supply fluid to the exhausted air line 34) 64a in the exhausted air line 34. The fluid jet nozzle 64a is placed such that the direction along the flow direction of the exhausted air line 34 is the same as the direction in which the fluid C is jetted. In other words, the fluid jet nozzle 64a is placed such that the portion near the opening from which the fluid is jetted is in the direction along the exhausted air line 34. The fluid jet nozzle 64a can prevent the jetted fluid C from colliding with the wall surface of the exhausted air line 34 by jetting the fluid C in the direction along the exhausted air line 34. Note that the fluid supply unit 61 can be provided with a guard pipe configured to guide the fluid C at the downstream of the nozzle of the fluid jet nozzle 64a inside the exhausted air line 34. Providing a guard pipe can also prevent the jetted fluid C from colliding with the wall surface of the exhausted air line 34. Although the fluid jet nozzle 64a is illustrated as a single nozzle in FIG. 2, the present invention is not limited to the this configuration. For example, the fluid supply line 64 is connected to a circular line 64b surrounding the outer side of the exhausted air line 34 such that a plurality of fluid jet nozzles 64a provided inside the exhausted air line 34 can be connected to a plurality of branch lines 64c connected to the exhausted air line 34 from the circular line 64b as illustrated in FIG. 3. Including a plurality of fluid jet nozzles 64a as illustrated in FIG. 3 can distribute and supply the fluid from a plurality of places and thus can uniformly supply the fluid in the exhausted air line 34. Note that, when being supplied to the exhausted air line 34, the fluid does not have to be in a liquid form. For example, the fluid can be in a mist form so as to be supplied to the exhausted air line 34 in a form in which the fluid is jetted more uniformly and more easily evaporates. Due to the same reason, the fluid can be supplied in a liquid drop form.

The fluid control valve 65 is provided on the fluid supply line 64 so as to open and close the fluid supply line 64 and switch the aperture thereof. Note that it is preferable that the fluid control valve 65 can adjust the aperture. However, it is sufficient that the fluid control valve 65 can at least adjust the opening.

The fluid pump 66 is provided between the fluid storage unit 63 and the fluid control valve 65 on the fluid supply line 64 so as to send the fluid C out of the fluid storage unit 63 to the exhausted air line 34.

The temperature detection unit 68 detects the temperature of the exhausted air A3 from the SOFC 13. The temperature detection unit 68 can be proximal to the SOFC 13 on the exhausted air line 34 so as to detect the temperature of the exhausted air A3 sent to the exhausted air line 34. The temperature detection unit 68 can be proximal to the SOFC 13 on the exhausted air line 34 so as to detect the temperature of the exhausted air line 34.

The NOx detection unit 69 detects the nitrogen oxide concentration in the flue gas G discharged from the gas turbine 11. The NOx detection unit 69 is provided on the flue gas line 53, specifically, is placed on the upper stream side than a flue gas treatment system on the flue gas line 53.

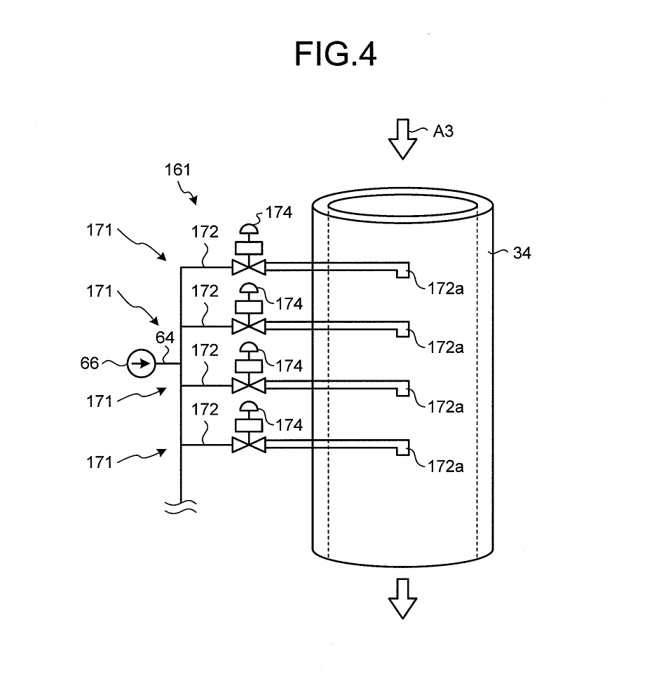

FIG. 4 is a diagram of the configuration of a part in another exemplary fluid supply unit in the power generating system according to the present embodiment. The fluid supply unit 61 in the above-mentioned embodiment is provided a nozzle or a plurality of nozzles in the circumferential direction of the exhausted air line 34. However, the present invention is not limited to the embodiment. A fluid supply unit 161 illustrated in FIG. 4 is branched into a plurality of units 171 on the lower stream side than the fluid pump 66. The units 171 each include a branch pipe 172 and a fluid control valve 174. The branch pipe 172 is provided with a fluid jet nozzle 172a inside the exhausted air line 34 as illustrated in FIG. 4. The fluid control valve 174 is capable of adjusting the aperture in addition to the open and close position. The units 171 are placed in the direction in which the exhausted air A3 flows in the exhausted air line 34 at predetermined intervals. This places the fluid jet nozzles 172a of the fluid supply unit 161 at different positions in the direction in which the exhausted air A3 flows in the exhausted air line 34.

The fluid supply unit 161 can include a plurality of fluid jet nozzles 172a in the direction in which the exhausted air A3 flows as illustrated in FIG. 4 and thus can distribute and uniformly supply the fluid from a plurality of places into the exhausted air line 34. As described above, the fluid supply unit can supply the fluid with distributing the fluid more and can uniformly supply the fluid into the exhausted air line 34 by including a plurality of fluid jet nozzles. This can equalize the temperatures in the exhausted oxidized gas line and can evaporate the supplied fluid more surely.

The fluid supply unit 161 can adjust the aperture in addition to the open and close of the branch pipe 172 by providing the fluid control valve 174 on the branch pipe 172. As described above, the fluid supply unit 161 is provided with a valve capable of adjusting the aperture and thus can control the amount of fluid to be supplied from each of the fluid jet nozzles 172a by controlling the aperture. Note that the fluid supply unit 161 controls the open and close position of the fluid control valve 174 and thus can adjust the supply quantity of fluid by controlling the balance between the time of opening and the time of closing. Further, the fluid supply unit 161 can adjust the supply quantity of fluid using the pressure supplying the fluid from the fluid pump 66. As described above, the fluid supply unit is preferably provided with a fluid control valve at least capable of switching the open and close position on the pipe supplying the fluid and is preferably provided a fluid control valve capable of adjusting the aperture in addition to the open and close position.

The control device 62 stores the upper limit and lower limit of the temperature of the exhausted air A3 in advance. The upper limit and lower limit of the temperature can arbitrarily be set in design. For example, the upper limit of the temperature is determined depending on the components and devices included in the exhausted air line 34. The lower limit of the temperature is a temperature in which the decrease in temperature of the exhausted air A3 affects the combustion in the combustor 22 of the gas turbine 11 and a temperature that causes the decrease in the power generation efficiency in the electric generator 12 driven by the gas turbine 11. Thus, the control device 62 controls the driving of the fluid supply unit 61 based on the temperature of the exhausted air A3 detected in the temperature detection unit 68.

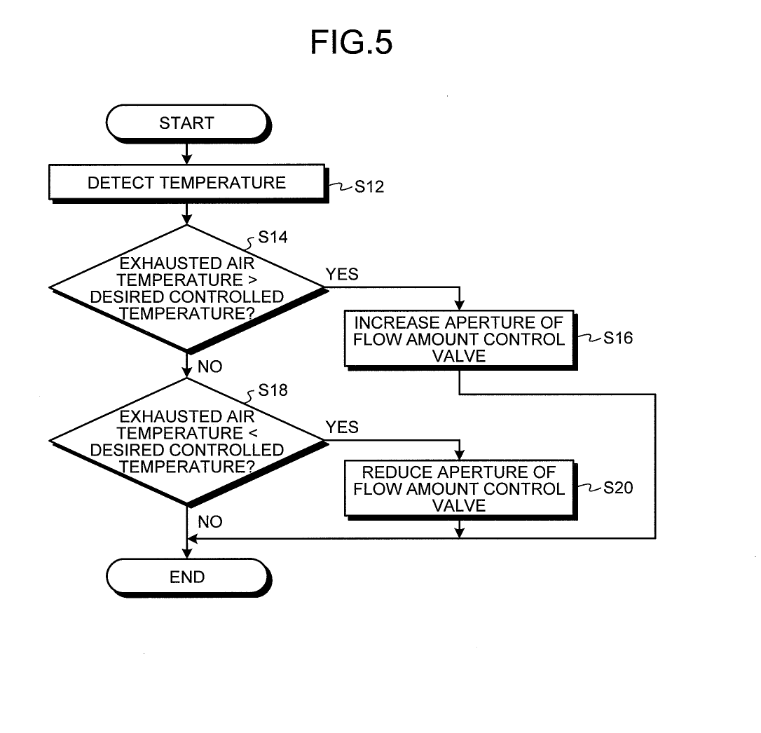

FIG. 5 is a flowchart describing an exemplary operation of the power generating system in the present embodiment. The control device 62 repeats the process illustrated in FIG. 5. The control device 62 detects the temperature using the temperature detection unit 68 (step S12) so as to determine whether the exhausted air temperature> the desired controlled temperature held (step S14). The desired controlled temperature is between the set upper limit and lower limit of the temperature in that case. The desired controlled temperature can include an allowable deviation of the base temperature. In other words, a temperature range having various values is used as the desired controlled temperature. In that case, the control device 62 determines whether the exhausted air temperature> the base temperature+the allowable deviation held.

When determining that the exhausted air temperature detected in the temperature detection unit 68 has exceeded the desired controlled temperature (the exhausted air temperature>the desired controlled temperature held) (Yes in step S14), the control device 62 increases the aperture of the fluid control valve 65 (step S16) and then terminates the present process. Note that the control device 62 controls the driving of the fluid pump 66 while controlling the fluid control valve 65. This increases the amount of the fluid C sent out of the fluid storage unit 63 to the exhausted air line 34 and thus increases the amount of the fluid C jetted from the fluid jet nozzle 64a into the exhausted air line 34.

When determining that the exhausted air temperature detected in the temperature detection unit 68 has not exceeded the desired controlled temperature (the exhausted air temperature the desired controlled temperature held) (No in step S14), the control device 62 determines whether the exhausted air temperature<the desired controlled temperature held (step S18). When the base temperature and the allowable deviation are set as the desired controlled temperature, the control device 62 determines whether the exhausted air temperature<the desired controlled temperature—the allowable deviation held. When determining that the exhausted air temperature detected in the temperature detection unit 68 is less than the desired controlled temperature (the exhausted air temperature<the desired controlled temperature held) (Yes in step S18), the control device 62 reduces the aperture of the fluid control valve 65 (step S20) and then terminates the present process. Note that the control device 62 controls the driving of the fluid pump 66 while controlling the fluid control valve 65. This reduces the amount of the fluid C sent out of the fluid storage unit 63 to the exhausted air line 34 and thus reduces the amount of the fluid C jetted from the fluid jet nozzle 64a into the exhausted air line 34. When determining that the exhausted air temperature detected in the temperature detection unit 68 is not less than the desired controlled temperature (the exhausted air temperature≧the desired controlled temperature held) (No in step S18), the control device 62 terminates the present process.

As described above, the power generating system 10 according to the present embodiment includes the SOFC 13, the exhausted air line 34 configured to send the exhausted air A3 from the SOFC 13, the temperature detection unit 68 configured to detect the temperature of the exhausted air A3 from the SOFC 13 or the temperature of the exhausted air line 34, the fluid supply unit 61 configured to supply the fluid C to the exhausted air A3 in the exhausted air line 34, and the control device 62 configured to control the driving of the fluid supply unit 61 based on the temperature detected with the temperature detection unit 68.

The power generating system 10 supplies the fluid from the fluid supply unit 61 to the exhausted air line 34 while detecting the temperature of the exhausted air A3 with the temperature detection unit 68 and controlling the supply quantity of fluid with the control device 62 based on the detected temperature of the exhausted air A3. This can reduce the temperature of the exhausted air A3 from the SOFC 13 and maintain the exhausted air A3 within a predetermined temperature range, and thus can prevent the components and devices included in the exhausted air line 34 and the exhausted air supply line 36 from having temperatures higher than their upper temperature limits. As a result, the components and devices included in the exhausted air line 34 for sending the exhausted air A3 can be prevented from being affected by the high temperature exhausted air. The assumed temperatures on the components and devices included in the exhausted air line 34 and the exhausted air supply line 36 can be reduced. Thus, a safe and low-cost power generating system can be designed.

The power generating system 10 can reduce the temperature of the exhausted air by supplying the fluid into the exhausted air line 34 using the fluid supply unit 61. This can simplify the pipe system and the configuration of the power generating system.

The power generating system 10 can reduce the temperature of the exhausted air and increase the flow amount of the exhausted air by supplying the fluid into the exhausted air line 34 with the fluid supply unit 61 and evaporating the supplied fluid. The power generating system 10 can increase the power generation amount using the gas turbine 11. This can protect the exhausted air line (exhausted oxidized gas line (the components and devices)) 34 configured to send the exhausted air (exhausted oxidized gas) and can efficiently use the sensible heat of the exhausted air (exhausted oxidized gas). Specifically, supplying the fluid into the exhausted air to be supplied to the gas turbine 11 can maintain the whole energy of the exhausted air passing through the heat recovery steam generator 51 after passing through the gas turbine 11 and can reduce the temperature of the exhausted air. In other words, the power generating system 10 maintains the whole energy of the exhausted air by increasing the whole flow amount of the exhausted air with reducing the temperature. In that case, the exhausted air is supplied to the combustor 22 such that the combustor 22 mixes the exhausted air with the exhausted fuel gas and the fuel gas and heats them in the combustion. Then, the flue gas passes through the turbine 23 and through the heat recovery steam generator 51 such that the heat of the flue gas is recovered. Thus, the energy is taken out from the flue gas in the power generation at the two places: the gas turbine 11 and the steam turbine 14. Thus, maintaining the exhausted air to have a higher energy can more efficiently take out the energy. In other words, this can increase the efficiency in comparison with reducing the temperature of the flue gas with a heat exchanger and use the heat obtained at the heat exchanger for a steam boiler and so on.

The method for operating the power generating system 10 according to the present embodiment includes sending the exhausted air from the SOFC 13 through the exhausted air line 34, detecting the temperature of the exhausted air from the SOFC 13, and determining the supply quantity of fluid based on the detected temperature of the exhausted air and supplying the determined supply quantity of fluid to the exhausted air line 34.

The power generating system 10 supplies the fluid to the exhausted air line 34 while detecting the temperature of the exhausted air A3 and controlling the supply quantity of fluid based on the detected temperature of the exhausted air A3. This can reduce the temperature of the exhausted air A3 from the SOFC 13 and maintain the exhausted air A3 within a predetermined temperature range. Thus, the exhausted air line 34 and the exhausted air supply line 36 that send the exhausted air A3 can be protected. Further, the flow amount of the exhausted air through the exhausted air line 34 can be increased. Thus, the heat of the exhausted oxidized gas can efficiently be used.

In the power generating system 10 according to the present embodiment, the fluid supply unit 61 includes the fluid storage unit 63 configured to store the fluid C, the fluid supply line 64 connecting the exhausted air line 34 to the fluid storage unit 63, the fluid control valve 65 provided on the fluid supply line 64, and the fluid pump 66 provided on the fluid supply line 64 and configured to send the fluid C out of the fluid storage unit 63 to the exhausted air line 34. The control device 62 controls the opening and closing of the fluid control valve 65 and the driving of the fluid pump 66 based on the temperature detected with the temperature detection unit 68.

Thus, controlling the apperture of the fluid control valve 65 and the driving of the fluid pump 66 and supplying the fluid to the exhausted air line 34 can reduce the temperature of the exhausted air to a predetermined temperature or lower and can increase the flow amount of the exhausted oxidized gas.

In the power generating system 10 according to the present embodiment, the fluid storage unit 63 stores the fluid C such that water as the fluid C is supplied from the fluid supply unit 61 to the exhausted air line 34. The water is evaporated when contacting the high temperature exhausted air A3 or the high temperature exhausted fuel gas L3. This can reduce the temperature of the exhausted air A3. Note that high-grade water such as pure water or purified water is preferably used as the water. This can prevent the deposition of impurities in the exhausted air line 34 and so on.

Note that the fluid supply unit 61 can store ethyl alcohol or methyl alcohol as the fluid C instead of the water in the fluid storage unit 63. In that case, the high temperature exhausted air A3 gasifies the ethyl alcohol or the methyl alcohol. This can reduce the temperature of the exhausted air A3. The gasified ethyl alcohol or methyl alcohol is burnt in the combustor 22.

In that case, it is preferable that the control device 62 determines the upper limit of the temperature of the exhausted air, for example, based on the upper temperature limit of the components and devices included in the pipe (the exhausted air line 34). For example, the upper limit of the temperature of the exhausted air is preferably set at less than 550° C. in which low-alloy steel can be used. The control device 62 sets the upper limit of the temperature at 550° C. as the upper temperature limit of the pipe and sets a temperature lower than the upper limit of the temperature by about 5% as the control value. Thus, operating the system with maintaining the temperature of the exhausted air at 520° C. or lower reduces load on the components and devices and thus can prevent the damage to the components and devices.

It is preferable that the control device 62 determines the lower limit of the temperature of the exhausted air based on the temperature range required by the combustor 22 in the gas turbine 11. It is preferable that the control device 62 controls the temperature such that the temperature is not cooled to the temperature required by the combustor 22 or lower and sets the lower limit of the temperature, for example, at 250° C. In that case, the lower limit of the temperature is determined within a temperature range required by the combustor and within a temperature range that does not affect the combustion. The temperature range varies depending on the combustor applied in the gas turbine 11 of the power generating system 10.

The control device 62 can adjust the increase and decrease in the aperture of the flow amount control valve based on the deviation between the set desired temperature and the measured temperature of the exhausted air. For example, the increase and decrease can be increased more largely as the deviation is larger. The control device 62 can control the aperture based on the actual aperture of the flow amount control valve or the order of the aperture. It is also preferable that the control device 62 performs a PID control in view of the delay in response and so on.

It is also preferable that the control device 62 determines the upper limit of the supply quantity of fluid based on the flow amount in which the exhausted air temperature is brought to the lower limit of the temperature, or the flow amount in which the evaporation can be completed in the exhausted air line so as to maintain the supply quantity at the upper limit or lower.

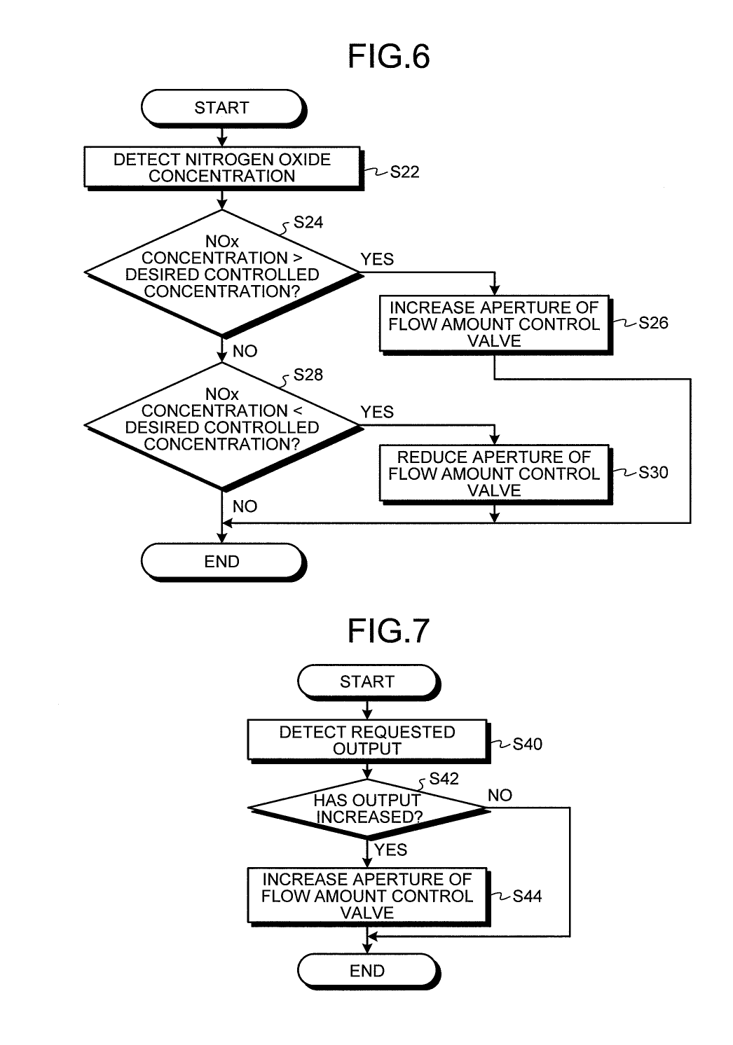

FIG. 6 is a flowchart describing an exemplary operation of the power generating system according to the present embodiment. Although the supply quantity of fluid is controlled based on the temperature of the exhausted air A3 detected in the temperature detection unit 68 in the above-mentioned embodiment, the supply quantity of fluid can be controlled based on the concentration of the nitrogen oxide in addition to the temperature of the exhausted air. In that case, the upper limit and lower limit of the nitrogen oxide concentration that can arbitrarily be set are set in the control device 62. The desired controlled concentration that is a value between the upper limit and lower limit of the concentration is also set in the control device 62. The desired controlled concentration can have a value or values having a given deviation, similarly to the desired controlled temperature. The control device 62 detects the nitrogen oxide concentration (NOx concentration) using the NOx detection unit 69 (step S22) so as to determine whether the NOx concentration>the desired controlled concentration held (step S24).

When determining that the NOx concentration detected in the NOx detection unit 69 has exceed the desired controlled concentration (the NOx concentration>the desired controlled concentration held) (Yes in step S24), the control device 62 increases the aperture of the fluid control valve 65 (step S26) and then terminates the present process. Note that the control device 62 controls the driving of the fluid pump 66 with controlling the fluid control valve 65. This increases the amount of the fluid C sent out of the fluid storage unit 63 into the exhausted air line 34 and thus increases the amount of the fluid C jetted from the fluid jet nozzle 64a into the exhausted air line 34.

When determining that the NOx concentration detected in the NOx detection unit 69 has not exceed the desired controlled concentration (the NOx concentration the desired controlled concentration held) (No in step S24), the control device 62 determines whether the NOx concentration<the desired controlled concentration held (step S28). When determining that the NOx concentration detected in the NOx detection unit 69 is less than the desired controlled concentration (the NOx concentration<the desired controlled concentration held) (Yes in step S28), the control device 62 reduces the aperture of the fluid control valve 65 (step S30) and then terminates the present process. Note that the control device 62 controls the driving of the fluid pump 66 with controlling the fluid control valve 65. This reduces the amount of the fluid C sent out of the fluid storage unit 63 into the exhausted air line 34 and thus reduces the amount of the fluid C jetted from the fluid jet nozzle 64a into the exhausted air line 34. When determining that the NOx concentration detected in the NOx detection unit 69 is not less than the desired controlled concentration (the NOx concentration the desired controlled concentration held) (No in step S28), the control device 62 terminates the present process.

As illustrated in FIG. 6, the power generating system 10 can prevent the increase in the nitrogen oxide concentration (NOx concentration) in the flue gas by controlling the supply of fluid based on the nitrogen oxide concentration. For example, when the nitrogen oxide concentration in the flue gas increases, increasing the supply quantity of fluid can reduce the amount of the nitrogen oxide generated in the combustor and thus can reduce the nitrogen oxide concentration in the flue gas.

In that case, the power generating system 10 preferably performs the combination of the process in FIG. 6 and the process in FIG. 5. Specifically, the power generating system 10 preferably controls, based on the NOx concentration, the supply quantity of fluid within a range in which the temperature of the exhausted air does not exceed the upper limit and lower limit of the temperature. Further, the power generating system 10 preferably reduces, based on the NOx concentration, the supply quantity of fluid within a range in which the temperature of the exhausted air does not exceed the upper limit of the temperature. Further, the power generating system 10 preferably determines to increase, maintain, or reduce the supply quantity of fluid according to the setting when the NOx concentration is equal to or higher than the desired controlled concentration. When determining, based on the previously set data, that the power generating system 10 is in operating condition in which the NOx concentration is increased, the power generating system 10 can increase the flow amount of the exhausted air by increasing the aperture of the flow amount control valve before being in such an operating condition. The power generating system 10 can also change the desired controlled temperature of the exhausted air into a low value.

FIG. 7 is a flowchart describing an exemplary operation of the power generating system in the present embodiment. The control device 62 can also control the supply quantity of fluid based on the desired output in addition to the temperature of the exhausted air. In that case, the requested output is the power generation amount for which a request is input such that the electric generator 12 connected to the gas turbine 11 generates power. The control device 62 can detect the requested output based on the input information and the detected information. The control device 62 detects the requested output (step S40) so as to determine whether the output has increased (step S42). When the increase amount of the output (power generation amount) has exceeded a predetermined threshold at that time, the control device 62 determines that the output has increased.

When determining that the requested output has increased (Yes in step S42), the control device 62 increases the aperture of the fluid control valve 65 (step S44) and then terminates the present process. At that time, the control device 62 can increase the flow amount of gas turbine fuel by increasing the aperture of the fluid control valve 65 if necessary. Note that the control device 62 controls the driving of the fluid pump 66 with controlling the fluid control valve 65. This increases the amount of the fluid C sent out of the fluid storage unit 63 into the exhausted air line 34 and thus increases the amount of the fluid C jetted from the fluid jet nozzle 64a into the exhausted air line 34. When determining that the requested output has not increased (No in step S42), the control device 62 terminates the present process.

Thus, by increasing the supply quantity of fluid, the power generating system 10 can increase the flow amount of exhausted oxidized gas to be supplied to the gas turbine within a range in which the temperature of the gas at the exit of the gas turbine combustor is not significantly reduced and can further increase the power to rotate the turbine in the gas turbine. This can increase the power generation amount of the power generating system. Increasing the flow amount of the gas turbine fuel within a range in which the temperature of the combustor in the gas turbine does not reach the upper limit can increase the power to rotate the turbine in the gas turbine and thus can increase the power generation amount of the power generating system if necessary. Thus, the power generating system 10 can respond to the increase in the requested output.

In that case, the power generating system 10 preferably performs the combination of the process in FIG. 7 and the processes in FIGS. 5 and 6. Thus, the power generating system 10 can perform an appropriate process in response to various conditions. For example, the power generating system 10 preferably controls, based on the request for output, the supply quantity of fluid within a range in which the temperature of the exhausted air does not exceed the lower limit and upper limit of the temperature. For example, when the output is largely lower than the request for output, increasing the aperture of the flow amount control valve within a range in which the temperature of the exhausted air does not exceed the lower limit and upper limit of the temperature increases the supply quantity of the fluid. In that case, simultaneously increasing the flow amount of the fuel gas in the gas turbine can increase the output more. When the atmospheric temperature rises, the maximum output of the gas turbine decreases. When the atmospheric temperature rises, the flow amount can be increased or the desired controlled temperature of the exhausted air can be decreased in order to prevent the decrease in the output.

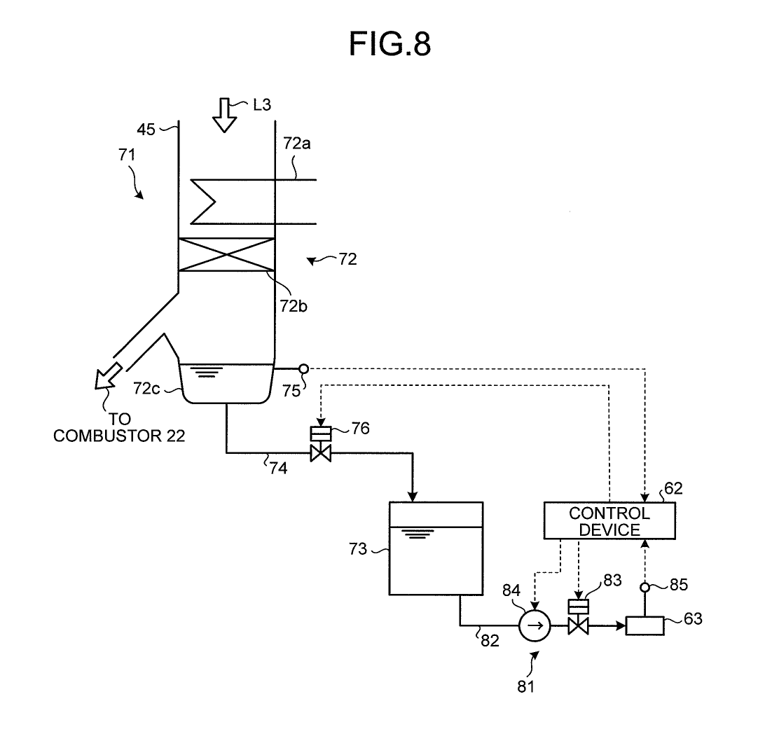

FIG. 8 is a diagram of the configuration of a part of the fluid supply unit in the power generating system in the present embodiment. Hereinafter, the configuration will be described with an example in which the water generated in the power generating system 10 is used as the fluid (condensable fluid) to be supplied. The power generating system 10 according to the present embodiment is provided with a water recovering device (water recovering unit) 71 as illustrated in FIG. 8. The water recovering device 71 extracts and recovers the water condensing in the system.

The water recovering device 71 can be provided, for example, on the discharge line 35, the exhausted fuel line 43, the discharge line 44, the exhausted fuel gas supply line 45, and the fuel gas recirculation line 49 in the power generating system 10. When the water recovering device 71 is provided on each of the lines 35, 43, 44, 45, and 49, the water is preferably recovered such that the flow amount of the exhausted oxidized gas A3 to be supplied to the gas turbine or the exhausted fuel gas to be supplied to the gas turbine is not significantly reduced. When being recovered on each of the lines 43 and 49, the water is preferably recovered as much as possible while the amount of the water as steam required for steam reforming is left. When the water recovering device 71 is provided on the flue gas line 53 at the exit of the gas turbine, the water is preferably recovered as much as possible.

FIG. 8 illustrates that the water recovering device 71 is provided on the exhausted fuel gas supply line 45 as a representative example of the lines. The exhausted fuel gas supply line 45 passes the exhausted fuel gas discharged from the SOFC 13 to the combustor 22 in the gas turbine as described above. The water is mixed into the exhausted fuel gas at a constant rate in that case. The water is evaporated because the water has a high temperature when being sent to the exhausted fuel gas supply line 45. Thus, the water included in the exhausted fuel gas L3 becomes water drops and condenses in the exhausted fuel gas supply line 45 when the temperature of the exhausted fuel gas L3 decreases. When the water drops flow into the combustor 22, a problem on the combustion in the combustor 22 possibly occurs. Thus, the water recovering device 71 extracts and recovers the water.

As illustrated in FIG. 8, the water recovering device 71 includes a water recovering mechanism 72, a water recovering container 73, a water recovering line 74, a storage amount detector 75, and a water recovering on-off valve 76.

The water recovering mechanism 72 is provided, for example, at a lower part in the exhausted fuel gas supply line 45, and includes a heat exchanger 72a, a water recovering device 72b, and a storage unit 72c. The heat exchanger 72a exchanges heat with the exhausted fuel gas to reduce the temperature of the exhausted fuel gas. A medium with which the exhausted fuel gas exchanges the heat is preferably a medium capable of recovering the generated heat at the other mechanisms, for example, is preferably the steam or feedwater flowing through the heat recovery steam generator 51, or the fuel used in the SOFC, or the gas turbine. The heat exchanger 72a produces a condition in which the water included in the exhausted fuel gas can readily be recovered by reducing the temperature of the exhausted fuel gas. The water recovering device 72b is placed on the lower stream below the heat exchanger 72a and is configured to separate and recover the water from the exhausted fuel gas L3. The water recovering device 72b separates the water, for example, by placing a mesh in the exhausted fuel line 43 to attach the water thereto, by providing a space in the exhausted fuel gas supply line 45 to place a plurality of wave-shaped plates in the space in order to attach the water to the plates, by forming a swirl flow in the exhausted fuel gas supply line 45 to use the centrifugal force to separate the water, or by pass the exhausted fuel gas on the upper side and store the water on the lower side. The storage unit 72c is a concave dented downward at the lower side in the exhausted air line 34 or the exhausted fuel line 43. The water separated in the water recovering device 72b falls and accumulates in the storage unit 72c.

The water recovering container 73 stores the water accumulating in the storage unit 72c. The water recovering container 73 is generally provided at the lower position than the storage unit 72c and at the position except for the exhausted air line 34 or the exhausted fuel gas supply line 45. When the pressure in the 72c is sufficiently higher than that in 73, or when a pump is provided on the line 74, the difference of the pressures or the discharge force of the pump can supply the water. Thus, the water recovering container 73 can be installed at the higher position than the 72c.

The water recovering line 74 is configured to pass the water accumulating in the storage unit 72c to the water recovering container 73 and connect the storage unit 72c to the water recovering container 73.

The storage amount detector 75 is provided at the storage unit 72c and detects the amount of the water accumulating in the storage unit 72c. The amount of the accumulating water detected in the storage amount detector 75 is input to the control device 62.

The water recovering on-off valve 76 is provided on the water recovering line 74 to open and close the water recovering line 74. The control device 62 controls the opening and closing of the water recovering on-off valve 76.

When the amount of the water accumulating in the storage unit 72c and detected in the storage amount detector 75 has exceeded a predetermined upper limit, the control device 62 controls the water recovering on-off valve 76 to open in the water recovering device 71. This sends the water in the storage unit 72c to the water recovering container 73 through the water recovering line 74. On the other hand, when the water in the storage unit 72c reduces and the amount of water detected in the storage amount detector 75 is less than a predetermined lower limit (or disappears), the control device 62 controls the water recovering on-off valve 76 to close. Note that, instead of the control of the openor close position is performed using the water recovering on-off valve 76, a control valve can be used instead of the water recovering on-off valve 76 to control the water level.

The water recovering device 71 is connected to the fluid storage unit 63 through a water supply device (water supply unit) 81. The water supply device 81 includes a water supply line 82 connecting the water recovering container 73 to the fluid storage unit 63. The water supply line 82 is provided with a water supply on-off valve 83, and a water supply pump 84. The water supply on-off valve 83 opens and closes the water supply line 82. The control device 62 controls the open or close position of the water supply on-off valve 83. The water supply pump 84 sends the water from the water recovering container 73 to the water supply line 82. The control device 62 controls the driving of the water supply pump 84. The fluid storage unit 63 is provided with a storage amount detector 85 configured to detect the amount of the stored water. The amount of the stored water detected in the storage amount detector 85 is input to the control device 62.

The control device 62 previously stores the lower limit of the amount of water stored in the fluid storage unit 63. When the amount of stored water detected in the storage amount detector 85 is lower than the lower limit, the control device 62 activates the water supply device 81. Note that the deficit in water can be supplied from outside when the water recovered by the water recovering device 71 is not enough to be supplied. On the other hand, the water can be discharged to the outside or can be used for another purpose when the water recovered by the water recovering unit is more than necessary amount.

As described above, the power generating system 10 according to the present embodiment includes the water recovering device 71 configured to extract and recover the water condense condensed in the system. The water recovered by the water recovering device 71 is stored as the fluid C in the fluid storage unit 63. Note that the power generating system 10 can share the water recovering container 73 with the fluid storage unit 63. In that case, it is not necessary to provide the water recovering container 73, the water supply device 81, the water supply line 82, or the water supply on-off valve 83.

Thus, extracting the water condensed in the system and storing the water in the fluid storage unit 63 can efficiently use the water condensed in the system as the fluid C.

The power generating system 10 according to the present embodiment includes the water recovering device 71 configured to extract and recover the water deposited in the system, the water supply line 82 connecting the water recovering device 71 to the fluid storage unit 63, the water supply on-off valve 83 provided on the water supply line 82, the water supply pump 84 provided on the water supply line 82 and configured to send the water out of the water recovering device 71 to the fluid storage unit 63, and the storage amount detector 85 configured to detect the amount of water stored in the fluid storage unit 63. When the amount of stored water detected in the storage amount detector 85 is lower than the lower limit, the control device 62 controls the water supply on-off valve 83 to open and drives the water supply pump 84.

Thus, when the amount of water stored in the fluid storage unit 63 decreases, the water is supplied from the water recovering device 71 that extracts and recovers the water condensed in the system to the fluid storage unit 63. Thus, the exhausted air A3 or the exhausted fuel gas L3 can be cooled using the water condensed in the system. Further, when the amount of water stored in the fluid storage unit 63 is reduced, the fluid storage unit 63 can be refilled with the water. As a result, a shortage of water is prevented and thus fluid can continuously be supplied to the exhausted air line 34.

Note that the water recovered by the water recovering device 71 and stored in the storage unit 72c can be used as the fluid C and can also be used for another purpose, for example, as the water with which the steam turbine is refilled.

The water recovering device 71 can include a combination of the heat exchanger 72a and a regenerated heat exchanger. Specifically, the water recovering device 71 reduces the temperature of the exhausted fuel gas L3 using the regenerated heat exchanger on the upper stream in the direction in which the exhausted fuel gas flows and then cools the exhausted fuel gas L3 using the cooler 72a to condense steam. After that, the water recovering device 71 can increase the temperature of the exhausted fuel gas using the regenerated heat exchanger on the lower stream than a water recovering device 71b. This can efficiently use the heat of the exhausted fuel gas with recovering the water in the exhausted fuel gas.

The water recovering device 71 can be provided on each line in the power generating system 10. The water recovering device 71 can also be provided on the flue gas line 53. More specifically, the water recovering device 71 is preferably provided on the lower stream than the heat recovery steam generator 51 on the flue gas line 53. This can recover the water included in the flue gas and also recover the water that the fluid supply unit 61 has supplied to the exhausted air A3.

A device for improving the water quality, for example, an ion-exchange resin is preferably placed on a path configured to supply the recovered drain to the fluid storage unit 63, for example, the water supply line 82 in the water recovering device 71. This can improve the quality of water supplied from the fluid supply unit 61 and thus can prevent impurities from attaching to the exhausted air line 34.

### REFERENCE SIGNS LIST

10 Power generating system
11 Gas turbine
12 Electric generator
13 SOFC (Solid oxide fuel cell: Fuel cell)
14 Steam turbine
15 Electric generator
21 Compressor
22 Combustor
23 Turbine
25 Air intake line
26 First compressed air supply line
27 First fuel gas supply line
31 Second compressed air supply line (Compressed oxidized gas line)
32 Control valve (First on-off valve)
33, 48 Blower
34 Exhausted air line (Exhausted oxidized gas line) 36 Exhausted air supply line (Exhausted oxidized gas supply line) 41 Second fuel gas supply line
42 Control valve
43 Exhausted fuel line
44 Discharge line
45 Exhausted fuel gas supply line
47 Control valve
49 Fuel gas recirculation line
50 Recirculation blower
51 Heat recovery steam generator
52 Turbine
53 Flue gas line
54 Steam supply line
55 Water supply line
56 Condenser
57 Water supply pump
61 Fluid supply unit
62 Control device (Control unit)
63 Fluid storage unit
64 Fluid supply line
65 Fluid control valve
66 Fluid pump
68 Temperature detection unit
69 NOx detection unit
71 Water recovering device (Water recovering unit) 81 Water supply device (Water supply unit)
82 Water supply line
83 Water supply on-off valve
84 Water supply pump
85 Storage amount detector

1. A power generating system comprising:
a fuel cell;
an exhausted oxidized gas line to which an exhausted oxidized gas is discharged from the fuel cell;
a gas turbine including a combustor configured to burn an exhausted oxidized gas passing through the exhausted oxidized gas line together with a fuel gas;
a temperature detection unit configured to detect a temperature of the exhausted oxidized gas discharged from the fuel cell or a temperature of the exhausted oxidized gas passing through the exhausted oxidized gas line;
a fluid supply unit configured to supply fluid to the exhausted oxidized gas line; and
a control unit configured to control an amount of the fluid to be supplied from the fluid supply unit to the exhausted oxidized gas line based on a detection result in the temperature detection unit.

2. The power generating system according to claim 1, wherein the fluid supply unit includes a plurality of nozzles configured to supply the fluid to the exhausted oxidized gas line.

3. The power generating system according to claim 1, further comprising:
an NOx concentration detection unit configured to detect a nitrogen oxide concentration in a flue gas discharged from the combustor,
wherein the control unit increases the amount of the fluid to be supplied from the fluid supply unit to the exhausted oxidized gas line when a nitrogen oxide concentration detected in the NOx concentration detection unit has exceeded a desired controlled concentration.

4. The power generating system according to claim 1, further comprising:
an electric generator configured to rotate with a rotational shaft of the gas turbine to generate power,
wherein the control unit increases the amount of the fluid to be supplied from the fluid supply unit to the exhausted oxidized gas line when an increase amount of requested output to the electric generator has exceeded an upper limit value.

5. The power generating system according to claim 1,
wherein the fluid supply unit includes
a fluid storage unit configured to store the fluid,
a fluid supply line connecting the exhausted oxidized gas line to the fluid storage unit,
a fluid control valve provided on the fluid supply line, and
a fluid pump provided on the fluid supply line and configured to send fluid out of the fluid storage unit to the exhausted oxidized gas line, and
the control unit controls an opening and closing of the fluid control valve and a driving of the fluid pump based on the temperature detected in the temperature detection unit.

6. The power generating system according to claim 5,
wherein water is stored as fluid in the fluid storage unit.

7. The power generating system according to claim 5, further comprising:
a water recovering unit configured to extract and recover water included in the exhausted oxidized gas or an exhausted fuel gas discharged from the fuel cell,
wherein the water recovered by the water recovering unit is stored as the fluid in the fluid storage unit.

8. A method for operating a power generating system, the method comprising:
sending an exhausted oxidized gas discharged from a fuel cell through an exhausted oxidized gas line;
detecting a temperature of the exhausted oxidized gas discharged from the fuel cell; and
determining, based on the detected temperature of the exhausted oxidized gas, an amount of fluid to be supplied in order to supply the determined amount of fluid to the exhausted oxidized gas line.
